(19) United States
(12) Patent Application Publication
(10) Pub. No.: US 2013/0166397 A1
(43) Pub. Date: Jun. 27, 2013

(54) SYSTEM AND METHOD FOR PROVIDING ADVERTISEMENT BASED ON MOTION OF MOBILE TERMINAL

(71) Applicant: NHN Business Platform Corporation, Seongnam-si (KR)

(72) Inventors: EunJa BYUN, Seongnam-si (KR); Sukku Yu, Seongnam-si (KR)

(73) Assignee: NHN Business Platform Corporation, Seongnam-si (KR)

(21) Appl. No.: 13/715,239

(22) Filed: Dec. 14, 2012

(30) Foreign Application Priority Data
Dec. 26, 2011 (KR) 10-2011-0142863

(51) Int. Cl. G06Q 30/02

(52) U.S. Cl. CPC G06Q 30/0277
USPC 705/14.73

(57) ABSTRACT

A system, method, and apparatus are provided for advertisement dissemination. The system may include: an advertisement information managing module configured to manage a plurality of items of advertisement information configured in a corresponding plurality of different advertisement presentation formats, the plurality of items of advertisement information being associated with a single advertisement material. The system may further include an advertisement information providing module configured to provide one of the plurality of items of advertisement information. The one item of advertisement information may be provided to a mobile terminal and is configured to be presented via the mobile terminal according to a first one of the plurality of advertisement presentation formats. The advertisement information providing module may be further configured to provide another one of the plurality of items of advertisement information to the mobile terminal based on motion information associated with a detected motion of the mobile terminal.

### CROSS-REFERENCE TO RELATED APPLICATION

This application claims priority from and the benefit of Korean Patent Application No. 10-2011-0142863, filed on Dec. 26, 2011, which is hereby incorporated by reference for all 6 purposes as if fully set forth herein.

### BACKGROUND

1. Field

Exemplary embodiments relate to a system and method for providing advertisements based on motion of a mobile terminal.

2. Discussion

Mobile advertising markets for disseminating advertisements via wired and is wireless mediums have been quickly growing. Mobile advertisements may be inserted into an application, a mobile web interface, and the like, of various electronic devices, such as a smart phone, a tablet personal computer (PC), and the like. Advertisement content may be provided (or otherwise conveyed) in a variety of forms, such as, for example, via sound, text, moving picture, etc., to a targeted customer via a portable device. In this manner, advertisement content may reach customers without restrictions on time, occasion, or place.

Convenient dissemination of mobile advertisements to customers, however, does not ensure such customers will, in fact, interact with the advertisement and, thereby, be enticed to act upon the product or offer. As such, a variety of techniques may be employed to peek or entice the interests of users. For example, Korea Patent Publication No. 2011-0046432, entitled “Method of Increasing Click Ratio of Banner Advertising on Mobile Phone or Tablet PC by Controlling Frequency of AD Exposure” discloses technology that entices a user to click on an advertisement by not displaying a banner advertisement clicked on by the user for a predetermined period of time and by enabling the user to use an advertisement-free application using a single click. While effective, the disclosed technology does not entice the user to click on an advertisement by arousing the interest of the user. Instead, the disclosed technology utilizes a forcing factor that requires the user to click on the advertisement in order to use an application. As such, the user is not voluntarily enticed by the advertisement, but is forced to click on the advertisement.

Therefore, there is a need for an approach that conveniently and efficiently provides mobile advertisement content to consumers by arousing and, thereby, enticing the interests of users to interact with the advertisement and/or act upon the product or offer proposed via the advertisement.

The above information disclosed in this Background section is only for enhancement of understanding of the background of the invention and, therefore, it may contain information that does not form any part of the prior art nor what the prior art may suggest to a person of ordinary skill in the art.

### SUMMARY

Exemplary embodiments provide an advertisement providing system, method, and apparatus that may arouse and, thereby, induce the interest of a user regarding mobile advertisements based on detected motion of a mobile terminal.

Exemplary embodiments provide an advertisement providing system, method, and apparatus that may increase advertising effect on a side of an advertiser and may increase advertising sales on a side of a media by more conveniently providing users with additional advertisement information based on detected motion of a mobile terminal that occurs while initial advertisement information is being consumed.

Additional aspects will be set forth in the detailed description which follows, and in part, will be apparent from the disclosure, or may be learned by practice of the invention.

According to exemplary embodiments, a system, includes: an advertisement information managing module configured to manage a plurality of items of advertisement information configured in a corresponding plurality of different advertisement presentation formats, the plurality of items of advertisement information being associated with a single advertisement material; and an advertisement information providing module configured to provide one of the plurality of items of advertisement information. The one item of advertisement information may be provided to a mobile terminal and is configured to be is presented via the mobile terminal according to a first one of the plurality of advertisement presentation formats. The advertisement information providing module may be further configured to provide another one of the plurality of items of advertisement information to the mobile terminal based on motion information associated with a detected motion of the mobile terminal.

According to exemplary embodiments, a system includes: an advertisement information providing module configured to: receive, from an advertisement platform, first advertisement information configured in association with a first advertisement presentation format, and provide the first advertisement information to a mobile terminal; a motion information receiver configured to receive motion information generated based on a motion of the mobile terminal, and an advertisement information requesting module configured to request, based on the motion information, the advertisement platform for second advertisement information configured in association with another advertisement presentation format. The advertisement information providing module may be further configured to: receive the second advertisement information from the advertisement platform, and provide the second advertisement information to the mobile terminal. The first advertisement information and the second advertisement information are both associated with the same advertisement material.

According to exemplary embodiments, a method includes: presenting, via a mobile terminal, advertisement information; detecting, via the mobile terminal, motion of the mobile terminal while the advertisement information is being presented; and switching, in response to detecting the motion, presentation of the advertisement information to presentation of related advertisement information. The advertisement information is presented in a different advertisement presentation format than the related advertisement information.

According to exemplary embodiments, a computer-readable storage medium configured to store at least one program, wherein the at least one program includes instructions that when executed by at least one processor are configured to cause the at least one processor at least to: present advertisement information via a mobile terminal; detect motion of the mobile terminal; and switch, in response to detection of the motion, presentation of the advertisement information to related advertisement information, wherein the advertisement information is presented in a different presentation format than the related advertisement information.

According to exemplary embodiments, a method includes: receiving motion information corresponding to second advertisement information related to first advertisement information; retrieving the second advertisement information based on the motion information; and transmitting, in response to retrieving the second advertisement information, the second advertisement information, wherein the first advertisement information is formatted in a different presentation format than the second advertisement information.

According to exemplary embodiments, a computer-readable storage medium configured to store at least one program, wherein the at least one program includes instructions that when executed by at least one processor are configured to cause the at least one processor at least to: receive motion information corresponding to second advertisement information related to first advertisement information; retrieve the second advertisement information based on the motion information; and transmit, in response to retrieval of the second advertisement information, the second advertisement information, wherein the first advertisement information is formatted in a different presentation format than the second advertisement information.

According to exemplary embodiments, an apparatus includes: at least one processor; and at least one memory comprising computer code, the at least one memory and the is computer code configured to, with the at least one processor, cause the apparatus at least to: present advertisement information in accordance with a first presentation format, detect motion of the apparatus, and switch, in response to detection of the motion, presentation of the advertisement information to presentation of related advertisement information in accordance with a second presentation format.

According to exemplary embodiments, an apparatus includes: at least one processor; and at least one memory comprising computer code, the at least one memory and the computer code configured to, with the at least one processor, cause the apparatus at least to: receive motion information corresponding to second advertisement information related to first advertisement information, retrieve the second advertisement information based on the motion information, and transmit, in response to retrieval of the second advertisement information, the second advertisement information, wherein the first advertisement information is formatted in a different presentation format than the second advertisement information.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate exemplary embodiments of the invention, and together with the description serve to explain the principles of the invention.

FIG. 1 is a view illustrating an example of providing a different item of is advertisement information with respect to the same advertisement material based on motion of a mobile terminal, according to exemplary embodiments.

FIG. 2 is a view illustrating another example of providing a different item of advertisement information with respect to the same advertisement material based on motion of a mobile terminal, according to exemplary embodiments.

FIG. 3 is a view illustrating another example of providing a different item of advertisement information with respect to the same advertisement material based on motion of a mobile terminal, according to exemplary embodiments.

FIG. 4 is a diagram illustrating a relationship among an advertiser, an advertisement platform, a publisher, and a user, according to exemplary embodiments.

FIG. 5 is a block diagram of an advertisement providing system, according to exemplary embodiments.

FIG. 6 is a flowchart of a process of providing an advertisement, according to exemplary embodiments.

FIG. 7 is a block diagram of an advertisement providing system, according to exemplary embodiments.

FIG. 8 is a flowchart of a process of providing an advertisement, according to exemplary embodiments.

FIG. 9 is a block diagram of an advertisement providing system, according to exemplary embodiments.

FIG. 10 is a flowchart of a process of providing an advertisement, according to exemplary embodiments.

### DETAILED DESCRIPTION OF THE ILLUSTRATED EMBODIMENTS

In the following description, for the purposes of explanation, numerous specific details are set forth in order to provide a thorough understanding of various exemplary embodiments. It is apparent, however, that various exemplary embodiments may be practiced without these specific details or with one or more equivalent arrangements. In other instances, well-known structures and devices are shown in block diagram form in order to avoid unnecessarily obscuring various exemplary embodiments.

In the accompanying figures, like reference numerals denote like elements.

When an element is referred to as being “connected to” another element, it may be directly connected to the other element or intervening elements may be present. When, however, an element is referred to as being “directly connected to” another element, there are no intervening elements present. For the purposes of this disclosure, “at least one of X, Y, and Z” may be construed as X only, Y only, Z only, or any combination of two or more of X, Y, and Z, such as, for instance, XYZ, XYY, YZ, and ZZ. Like numbers refer to like elements throughout. As used herein, the term “and/or” includes any and all combinations of one or more of the associated listed items.

Although the terms first, second, third, etc., may be used herein to describe various elements, components, regions, layers, and/or sections, these elements, components, regions, layers, and/or sections should not be limited by these terms. These terms are only used to distinguish one element, component, region, layer, or section from another element, component, region, layer, or section. Thus, a first element, component, region, layer, or section that is discussed below may be termed a second element, component, region, layer, or section without departing from the teachings of the present invention.

Spatially relative terms, such as “beneath,” “below,” “lower,” “above,” “upper,” and/or the like, may be used herein for descriptive purposes and, thereby, to describe one element or feature's relationship to another element(s) or feature(s) as illustrated in the drawings. Spatially relative terms are intended to encompass different orientations of an apparatus in use or operation in addition to the orientation depicted in the drawings. For example, if the apparatus in the drawings is turned over, elements described as “below” or “beneath” other elements or features would then be oriented “above” the other elements or features. Thus, the exemplary term “below” can encompass both an orientation of above and below. Furthermore, the apparatus may be otherwise oriented (e.g., rotated 90 degrees or at other orientations) and, as such, the spatially relative descriptors used herein are to be interpreted accordingly.

The terminology used herein is for the purpose of describing particular embodiments only and is not intended to be limiting. As used herein, the singular forms “a,” “an,” and “the” are intended to include the plural forms as well, unless the context clearly indicates otherwise. Moreover, the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this disclosure is a part. Terms, such as those defined in commonly used dictionaries, should be interpreted as having a meaning that is consistent with their meaning in the context of the relevant art and will not be interpreted in an idealized or overly formal sense, unless expressly so defined herein.

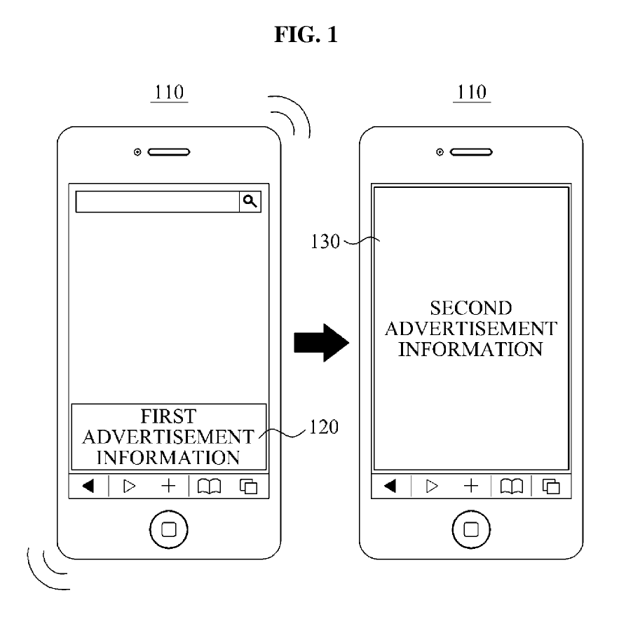

FIG. 1 is a view illustrating an example of providing a different item of advertisement information with respect to the same advertisement material based on motion of a mobile terminal, according to exemplary embodiments.

As seen in FIG. 1, first advertisement information 120 produced in the form of a display advertisement is displayed on a screen of the mobile terminal 110. In this manner, the display of first advertisement information 120 is replaced with display of second advertisement information 130 in response to motion of the mobile terminal 110. According to exemplary embodiments, the second advertisement information 130 is an expanded version of the first advertisement information 120. For example, the second advertisement information 130 may provide additional and/or alternative details regarding a product or service not otherwise provided via the first advertisement information 120. As such, the user may be enticed to interact with the first advertisement information 120 to thereby acquire the second advertisement information 130. To this end, FIG. 1 demonstrates a process of sensing motion of the mobile terminal 110 occurring in response to an action of a user, for instance, waving the mobile terminal 110. Based on sensing (or otherwise detecting) the motion, the mobile terminal 110 is configured to replace the first advertisement information 120 with the second advertisement information 130. In this manner, the second advertisement information 130 is displayed via mobile terminal 110.

According to exemplary embodiments, the display of the second advertisement information 130 may be provided via a different advertisement display form than the advertisement display form of the first advertisement information 120. For instance, the different advertisement display form may include at least one of a first advertisement display form for advertisement information that is displayed on an advertisement area of a page provided is to the mobile terminal 110, a second advertisement display form for advertisement information that is displayed on a layer overlaid on the page, a third advertisement display form for advertisement information that is displayed on a popup page that is popped up in association with the page, a fourth advertisement display form for advertisement information that is displayed in response to control of an application installed in the mobile terminal 110, a fifth advertisement display form for advertisement information in which a size or content of the advertisement information configured in one of the first advertisement display form through the fourth advertisement display form is expanded, a sixth advertisement display form for displaying advertisement information that is configured as a moving picture, and a seventh advertisement display form for advertisement information that is displayed on a landing page. It is contemplated; however, that various alternative and/or additional advertisement display forms for advertisement information may be utilized, such as, for example, an advertisement display form for advertisement information that is configured as audible content or tactile content, an advertisement display form for advertisement information that is configured as a ticker tape, etc. To this end, it is noted that the advertisement information may be considered as being presented via mobile terminal 110 in any suitable manner, whether audible, visual, and/or tactile.

Furthermore, while the sensed motion of the mobile terminal 110 has been described in association with a “shaking” motion, it is contemplated that any other and/or additional suitable motion(s) may be utilized, such as, for example, jerking motions, twisting motions, tapping motions, twirling motions, tilting motions, turning motions, etc. It is further contemplated that the sensed motions may be pattern motions, e.g., motioning the mobile device 110 in a linear and/or non-linear path, such as, for instance, an arcuate path. To this end, the sensed motion may be predefined and, thereby, stored in a memory (not shown) of mobile is terminal 110. These predefined motions may be user-defined, manufacturer defined, advertiser defined, producer defined, etc.

According to exemplary embodiments, mobile terminal 110 may be further configured to provide “hints” to users as to what type of motions may be utilized to alter the presentation of advertisement information. For instance, in addition to the display of the first advertisement information 120, the mobile terminal may display a “waving” action hinting to the user that performing such an action (e.g., manipulating the mobile terminal 110 in the described and/or illustrated manner) may be utilized to cause the first advertisement information 120 to the switched to the second advertisement information 130. To this end, various actions may be displayed (or otherwise presented), whether singly or in combination to inform the user that such actions may be utilized to toggle through various advertisement information and/or various advertisement presentations forms. As will become more apparent below, it is contemplated that the “hints” may be utilized to describe any of the detectable motions described herein and may be presented to users via audible, tactile, and/or visual indicia.

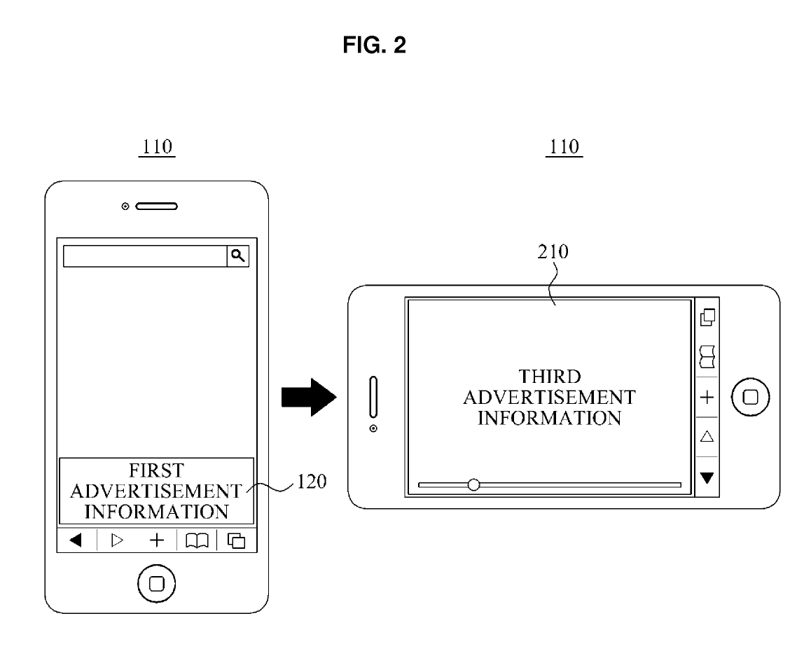

FIG. 2 is a view illustrating another example of providing a different item of advertisement information with respect to the same advertisement material based on motion of the mobile terminal 110, according to exemplary embodiments.

As seen in FIG. 2, first advertisement information 120 produced in the form of a display advertisement is displayed on a screen of the mobile terminal 110. In this manner, the display of the first advertisement information 120 is replaced with display of third advertisement information 210 that is a moving picture, in response to a motion of the mobile terminal 110 whereby the third advertisement information 210 is displayed. For example, FIG. 2 illustrates a process of sensing a motion of the mobile terminal 110 occurring in response to an action of a is user rotating (e.g., horizontally rotating) the mobile terminal 110, which causes the mobile terminal 110 to replace the first advertisement information 120 with the third advertisement information 210 in response to the motion and, thereby, displaying the third advertisement information 210. To this end, the third advertisement information 210 may include audible content that is presented via mobile terminal 110 via one or more transducers (not shown).

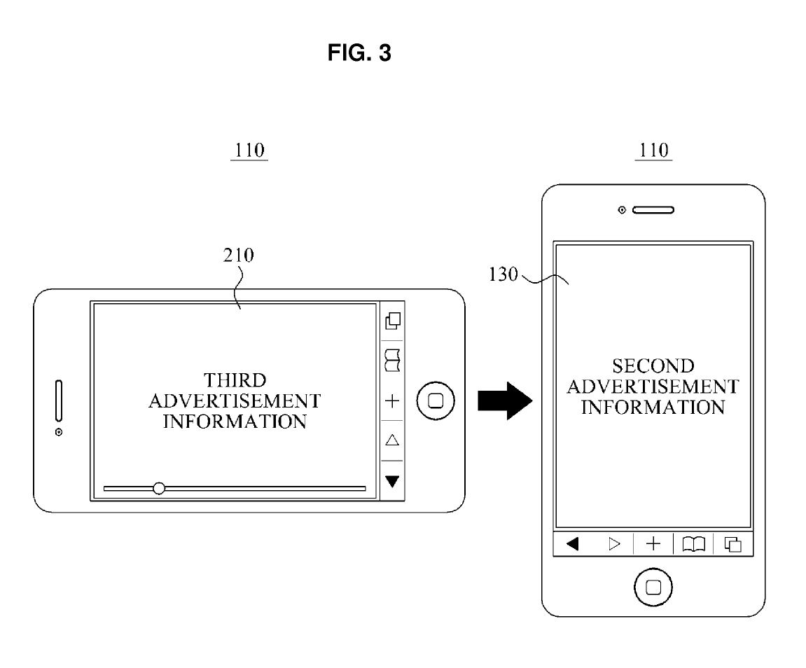

FIG. 3 is a view illustrating another example of providing a different item of advertisement information with respect to the same advertisement material based on motion of the mobile terminal 110, according to exemplary embodiments. As seen in FIG. 3, the third advertisement information 210 (e.g., a moving picture advertisement displayed on a screen of the mobile terminal 110) is replaced with the second advertisement information 130 (e.g., an expanded advertisement), in response to a motion of the mobile terminal 110 being detected while the third advertisement information 210 is displayed. For example, a motion of the mobile terminal 110 may be sensed in response to an action of a user rotating (e.g., vertically rotating) the mobile terminal 110, such that mobile terminal 110 replaces the third advertisement information 210 with the second advertisement information 130 in response to detecting the motion. To this end, the mobile terminal 110 causes the second advertisement information 130 to be displayed.

The first advertisement information 120, the second advertisement information 130, and the third advertisement information 210 described above with reference to FIGS. 1-3 may be configured in different advertisement display forms with respect to a single advertisement material. As described above, by changing a variety of items of advertisement information configured in different advertisement display forms with respect to a single identical advertisement material based on a motion of a mobile terminal and thereby displaying is advertisement information to users in a variety of manners, it is possible to induce a user to have interest in an advertisement, and to further conveniently receive additional information associated with a displayed advertisement. In addition, on a side of an advertiser, it is possible to enhance the advertising effect. On a side of media, it is possible to increase advertising sales.

It is generally noted that the examples of FIGS. 1-3 are only for ease of understanding, and thus, exemplary embodiments are not limited thereto. A motion of the mobile terminal 110 may be variously defined through combination of waving, turning over, rotation, movement, and the like with a corresponding direction. Also, the motion of the mobile terminal 110 may include a motion of a user, for example, a gesture of a hand, a motion of a touched finger, blinking of an eye, a motion of a pupil, predetermined sound, a voice command, and the like. The above motion may be measured through a variety of methods using at least one sensor, for example, a gyroscope, a gravity sensor, an illumination sensor, an acceleration sensor, a terrestrial sensor, a proximity sensor, a pressure sensor, a touch sensor, a microphone, and/or a camera, which is embedded in or attached to the mobile terminal 110.

In response to each motion or each of motion patterns in which the above motions are combined, an advertisement display form to be provided may be set. For example, based on a motion of the mobile terminal 110 that occurs in response to an action of the user waving the mobile terminal 110, a moving picture advertisement may be displayed instead of displaying an expanded advertisement. Alternatively, advertisement information may be configured in an advertisement display form in which the advertisement information is displayed using a separate layer or a popup page, and thereby be displayed. Also, an advertisement display form of advertisement information to be changed based on a motion of turning over the mobile terminal 110 may be preset. An advertisement display form to be changed may be preset for each waving is direction of the mobile terminal 110, for example, forward and backward, up and down, and the like. That is, in addition to the examples of FIGS. 1-3, all of the cases in which the advertisement display form is changed or terminated based on the motion of the mobile terminal 110 may be included.

Accordingly, it is noted that the motion of the mobile terminal 110 may be detected in any one or more of six degrees of freedom, e.g., heaving, swaying, surging, pitching, yawing, and/or rolling, as well as combinations thereof. As such, one or more of these motions may be combined into one or more combinatory motions. Furthermore, repeated motions of a similar or different kind may be utilized to toggle through various advertisement information and/or display forms of such advertisement information.

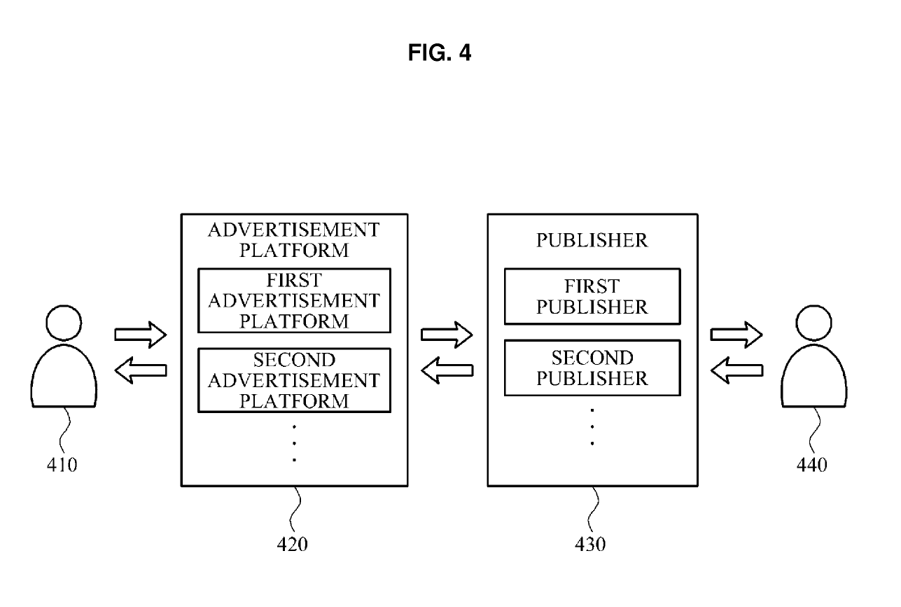

FIG. 4 is a diagram illustrating a relationship among an advertiser 410, an advertisement platform 420, a publisher 430, and a user 440, according to exemplary embodiments. The advertiser 410 may correspond to a terminal, such as a PC, a smart phone, and the like, that is used by the advertiser 410. In this manner, the advertiser 410 is a creator or supplier of advertisement material. The user 440 may indicate a mobile terminal that is used by the user 440. In this manner, the user 440 is a consumer of the advertisement material. Further, the publisher 430 may relate to a networking apparatus, such as a workstation, server, etc. As such, the publisher may be considered a distributor of advertisement material. Accordingly, an arrow indicator of FIG. 4 may indicate that data may be transmitted and received using a wired/wireless network among the terminal used by the advertiser 410, the advertisement platform 420, the publisher 430, and the mobile terminal used by the user 440.

The advertisement platform 420 may perform bidding for an advertisement of the advertiser 410, matching between an advertisement and a keyword, sorting of advertisements or advertisers, providing an advertisement to the publisher 430, and charging according to a display of the advertisement, and/or the like. General technical description of the advertisement platform 420 may be understood by referring to the related art about a platform such as a search advertisement, a banner advertisement, and the like, that are transferred via, for instance, the Internet, and thus, a further detailed description will be omitted here. It is noted, however, that advertisement platform 420 may comprise computing hardware, as well as include one or more components configured to execute the processes described herein. In exemplary embodiments, advertisement platform 420 may embody one or more application servers accessible to advertisers 410 over one or more communication networks, such as one or more wired and/or wireless communication networks. To this end, advertisement platform 420 is also accessible to publisher 430, which may likewise be (or include) a platform architecture. In this manner, advertisement platform 420 may provide a user interface, e.g., web portal or other networked application, to permit advertisers to access the features and functionality of advertisement platform 420.

The publisher 430 may provide the user 440 with a site or an application of the publisher 430, and may provide the user 440 with advertisement information received from the advertisement platform 420, using the site or the application. As such, publisher 430 may provide a user interface, e.g., web portal or other networked application, to permit users to access the features and functionality of publisher 430 via mobile terminals 110. According to exemplary embodiments, publisher 430 may be configured to exchange information between mobile terminals 110 and a web browser or other network-based application or system, such as a voice browser or interactive voice recognition system.

According to exemplary embodiments, each of a plurality of individual is advertisement platforms, for example, a first advertisement platform, a second advertisement platform, and the like, included in (or as part of) the advertisement platform 420 may display advertisement information using at least one individual publisher among a plurality of individual publishers, for example, a first publisher, a second publisher, and the like, included in (or as part of) the publisher 430. In this manner, it is noted that various advertisement platforms of advertisement platform 420 may be provided at a single location or in a distributed fashion. The same may be true of the individual publishers of publisher 430. Additionally (or alternatively), each of the plurality of individual publishers, for example, the first publisher, the second publisher, and the like, included in the publisher 430 may receive advertisement information using at least one individual advertisement platform among the plurality of individual advertisement platforms, for example, the first advertisement platform, the second advertisement platform, and the like, included in the advertisement platform 420, and may provide the received advertisement information to the user 440.

An advertisement providing system, according to exemplary embodiments, may be one of systems associated with an individual advertisement platform, or may be a system included in the one of the systems associated with the individual advertisement platform. An advertisement providing system, according to exemplary embodiments, may be one of systems associated with an individual publisher, or may be a system included in the one of the systems associated with the individual publisher. To this end, it is noted that an advertisement providing system, according to exemplary embodiments, may correspond to a mobile terminal 110 of a user 440, such that the mobile terminal 110 is configured to provide the features and functionality of the advertisement platform 420 and the publisher 430. To this end, it is noted that features and functions of the various components of FIG. 4, i.e., the advertiser 410, the is advertisement platform 420, the publisher 430, and the user 440, may be assumed (or otherwise provided by) one or more of the other components of the FIG. 4.

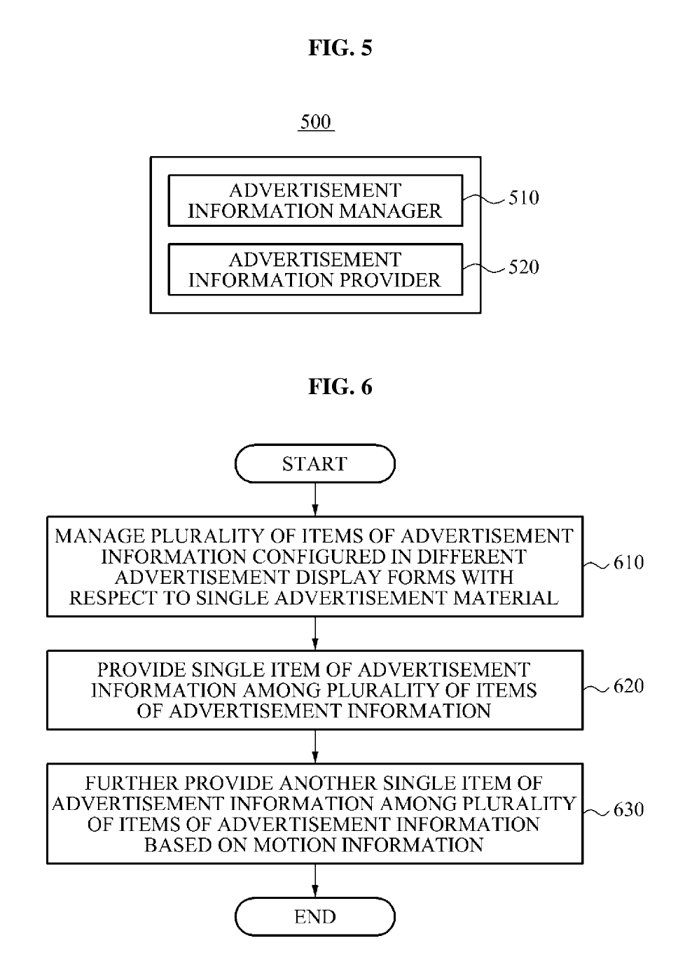

FIG. 5 is a block diagram of an advertisement providing system 500, according to exemplary embodiments. As described above, the advertisement providing system 500 may be one of systems associated with an individual advertisement platform, or may be a system included in the one of the systems associated with the individual advertisement platform. Referring to FIG. 5, the advertisement providing system 500 may include an advertisement information manager 510 and an advertisement information provider 520. It is noted that the advertisement information manager 510 and/or the advertisement information provider 520 may be provided as hardware, software, or a combination thereof, such as one or more units, modules, processors, etc., or one or more processes executed by one or more units, modules, processors, etc.

According to exemplary embodiments, the advertisement information manager 510 may be configured to manage a plurality of items of advertisement information that is configured in different advertisement display forms with respect to a single advertisement material or campaign. That is, with respect to a single advertisement material that an advertiser desires to disseminate, a plurality of items of advertisement information may be produced in different advertisement display forms. The advertisement information manager 510 may manage, for each advertisement material, the plurality of items of advertisement information produced in a variety of advertisement display forms. To this end, the various advertisement display forms may be managed (e.g., stored) in association with detectable motion conditions. For instance, a first advertisement display form may be associated with a first detected motion, a second advertisement display form may be associated with a second detected motion, and like. In this manner, the advertisement information manager 510 may be configured to provide advertisement material in various advertisement display forms based on a received request or query including, for instance, motion information associated with a detected motion, as will become more apparent below.

According to exemplary embodiments, the advertisement information provider 520 may be configured to provide a single item of advertisement information among the plurality of items of advertisement information. The single item of advertisement information may be provided to the mobile terminal 110 of the user 440 and be displayed on a screen of the mobile terminal 110 or otherwise presented to the user 440 via the mobile terminal 110, such as via one or more audible, tactile, and/or visual presentation mechanisms. For example, the advertisement information provider 520 may provide advertisement information to a server, e.g., publisher 430, configured to provide a service to the mobile terminal 110, and the advertisement information may be provided to the mobile terminal 110 through the server. In this manner, the server may act as a proxy between the mobile terminal 110 and the advertisement information manger 510. As noted, the server may be a system of the individual publisher described above with reference to FIG. 4. In this case, the provided advertisement information may be displayed on a screen of the mobile terminal. As another example, the advertisement information provider 520 may directly provide the advertisement information to the mobile terminal 110. Still further, the advertisement providing system 500 may be executed on or by mobile terminal 110.

The advertisement information provider 520 may further provide another single item of advertisement information among the plurality of items of advertisement information based on motion information that is generated based on a motion of the mobile terminal 110. For example, when the motion of the mobile terminal 110 is sensed while, for instance, the single is item of advertisement information is being displayed on or by the mobile terminal 110, the mobile terminal 110 may generate and transmit motion information. The motion information may be transmitted to the server, e.g., the publisher 430, and then be transferred to the advertisement providing system 500, e.g., advertisement platform 420, through the server. It is also noted that the motion information may be additionally or alternatively directly transferred to the advertisement providing system 500. In this case, an advertisement display form of advertisement information to be provided may be determined based on the motion information. The advertisement information provider 520 may further provide advertisement information that is configured using the determined advertisement display form as the other item of advertisement information. When mobile terminal 110 is configured to implement advertisement providing system 500, the generated motion information may be provided as input to an executing program, such that the executing program is configured to retrieve the other item of advertisement information based on the received motion information. In this manner, the advertisement information may be stored on or accessible to the mobile terminal 110, such as stored to a memory (not shown) of the mobile terminal 110, stored in a networked repository (not illustrated) accessible to the mobile terminal 110 and/or the like.

Here, the motion information may be generated based on the motion of the mobile terminal 110 that is sensed based on an output value of at least one sensor included in the mobile terminal 110. The output value may include an output value of the at least one sensor while the single item of advertisement information is being displayed on the screen of the mobile terminal 110 or otherwise being presented to a user 440 via the mobile terminal 110. As described above, based on the motion of the mobile terminal 110 sensed while the single item of advertisement information is being displayed on the mobile terminal 110, advertisement information in a is different advertisement display form may be provided to the mobile terminal 110, which may be configured to further pique the users interest regarding the advertisement material.

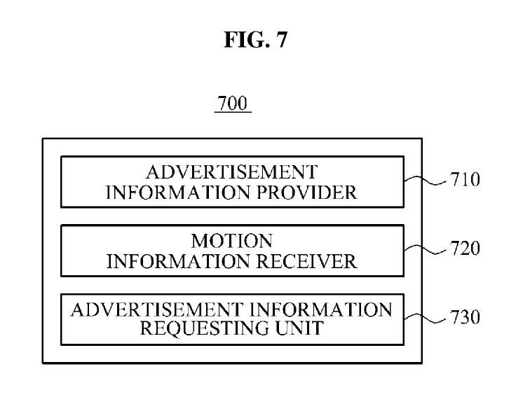

FIG. 6 is a flowchart of a process of providing an advertisement, according to exemplary embodiments. For illustrative purposes, the process will be described in association with the advertisement providing system 500 of FIG. 5. It is noted that the steps of the process may be performed in any suitable order, as well as combined or separated in any suitable manner.

In operation 610, the advertisement providing system 500 may manage a plurality of items of advertisement information that is configured in different advertisement display forms with respect to a single advertisement material. That is, with respect to a single advertisement material that an advertiser desires to disseminate, a plurality of items of advertisement information may be produced in different advertisement display forms. The advertisement providing system 500 may manage, for each advertisement material, the plurality of items of advertisement information produced in a variety of advertisement display forms. These plurality of items of advertisement information in the variety of advertisement display forms may be stored in association with various detectable motion conditions (or information), which may be utilized by the advertisement providing system 500 to provide appropriate advertisement information in an appropriate display form based on received motion information.

In operation 620, the advertisement providing system 500 may provide a single item of advertisement information among the plurality of items of advertisement information to mobile terminal 110. The single item of advertisement information may be provided to the mobile terminal 110 of the user 440 and be displayed on a screen of the mobile terminal 440; however, it is also contemplated that any other suitable presentation form may be utilized to is convey the advertisement information to the user 440. For example, the advertisement providing system 500 may provide advertisement information to a server configured to provide a service to the mobile terminal 110, and the advertisement information may be provided to the mobile terminal 110 through the server. The server may be a system of the individual publisher described above with reference to FIG. 4. In this case, the provided advertisement information may be displayed on a screen of the mobile terminal 110. As another example, the advertisement providing system 500 may directly provide the advertisement information to the mobile terminal 110. In yet another example, the advertisement information may be retrieved by the mobile terminal 110 and, thereby, presented to the user 440 based on one or more detectable conditions or instructions stored on the mobile terminal 100.

In operation 630, the advertisement providing system 500 may further provide another single item of advertisement information among the plurality of items of advertisement information based on motion information that is generated based on a motion of the mobile terminal 110. For example, when the motion of the mobile terminal 110 is sensed while the single item of advertisement information is being displayed on the motion terminal 110, the mobile terminal 110 may generate and transmit motion information. For instance, the motion information may be transmitted to the server and then be transferred to the advertisement providing system 500 through the server. Additionally (or alternatively), the motion information may be directly transferred to the advertisement providing system 500. It is further noted that, if mobile terminal 110 provides advertisement providing system 500, the generated motion information may be input to an executing program of the mobile terminal 110. In this manner, an advertisement display form of advertisement information to be provided may be determined based on the motion information.

In operation 630, the advertisement providing system 500 may further provide advertisement information that is configured using the determined advertisement display form as the other item of advertisement information. As such, the advertisement providing system 500 may be configured to directly transmit the advertisement information in the determined advertisement display form to the mobile terminal 110 and/or may indirectly transmit the advertisement information in the determined advertisement display form to the mobile terminal via the aforementioned server. When, for instance, the advertisement providing system 500 is executed on the mobile terminal 110, the mobile terminal 110 may retrieve the advertisement information in the determined advertisement display form from, for example, an internal memory or an accessible memory/networked repository.

As previously mentioned, the motion information may be generated based on the motion of the mobile terminal 110 that is sensed based on an output value of at least one sensor included in the mobile terminal 110. The output value may include an output value of the at least one sensor while the single item of advertisement information is being displayed on the screen of the mobile terminal 110 or otherwise presented to user 440. As described above, based on the motion of the mobile terminal 110 sensed while the single item of advertisement information is being displayed on the mobile terminal 110, advertisement information in a different advertisement display form may be provided to the mobile terminal. It is generally noted that the different advertisement display form may be configured to provide the user 440 with additional advertisement information not otherwise discernible via the initially provided advertisement information in the initially provided advertisement display form. As such, the user 440 may be enticed to interact with both the initially provided advertisement information and the subsequently provided advertisement information so as to learn about and take advantage is of the complete advertisement material being conveyed to the user 440.

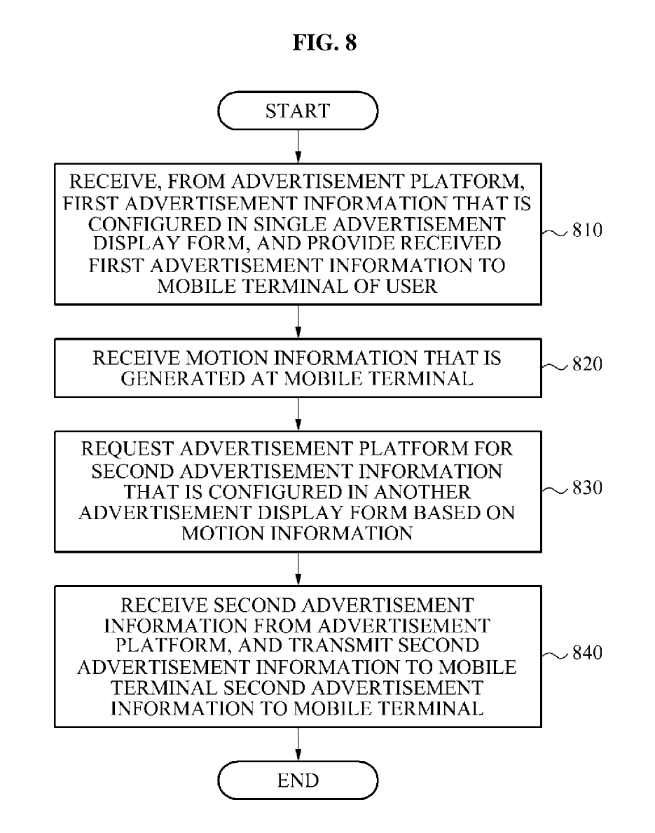

FIG. 7 is a block diagram of an advertisement providing system 700, according to exemplary embodiments. The advertisement providing system 700 may be one of systems associated with an individual publisher, or may be a system included in the one of the systems associated with the individual publisher. Referring to FIG. 7, the advertisement providing system 700 may include an advertisement information provider 710, a motion information receiver 720, and an advertisement information requesting unit 730. It is noted that the advertisement information provider 710, the advertisement information requesting unit 730, and the motion information receiver 720 may be provided as hardware, software, or a combination thereof, such as one or more units, modules, receivers, processors, etc., or one or more processes executed by one or more units, modules, receivers, processors, etc. As with the advertisement information system 500 of FIG. 5, the advertisement information system 700 of FIG. 7 may be implemented by the mobile terminal 110.

According to exemplary embodiments, the advertisement information provider 710 may be configured to receive, from an advertisement platform (e.g., advertisement platform 420), first advertisement information that is configured in a single advertisement display form, and may provide the received first advertisement information to a mobile terminal 110 of a user 440. The advertisement platform may correspond to an individual advertisement platform described above with reference to FIG. 4.

The motion information receiver 720 may be configured to receive motion information that is generated based on a detected motion of the mobile terminal 110. The motion information may be generated based on the motion of the mobile terminal 110 that is sensed based on an output value of at least one sensor included in the mobile terminal 110. The output is value may include an output value of the at least one sensor while the single item of advertisement information is being displayed on the screen of the mobile terminal 110 or otherwise presented to the user 440 via the mobile terminal 110. As described above, based on the motion of the mobile terminal 110 sensed while the single item of advertisement information is being displayed on the mobile terminal 110, advertisement information in a different advertisement display form may be provided to the mobile terminal 110.

The advertisement information requesting unit 730 may request the advertisement platform 420 for second advertisement information that is configured in another advertisement display form based on the motion information. That is, the advertisement information requesting unit 730 may verify the advertisement display form based on the motion information that is generated based on the detected motion of the mobile terminal 110, and may request the advertisement platform 420 for the advertisement information configured in the verified advertisement display form, as the second advertisement information.

In this instance, the advertisement information provider 710 may receive the second advertisement information from the advertisement platform 420, and may further provide the second advertisement information to the mobile terminal 110. In those instances when mobile terminal 110 is configured to implement the advertisement information system 700, the motion information receiver 720 may be configured to receive the motion information from the above-noted sensor(s) and, thereby, provide the motion information to the advertisement information requesting unit 730. As such, the advertisement information requesting unit 730 may request the second advertisement information from the advertisement platform 420 or may request the second advertisement information from a memory of or accessible to the mobile terminal 110. As such, the second advertisement information may be provided to the mobile is terminal 110 for presentation to the user 440.

According to exemplary embodiments, the first advertisement information displayed on the mobile terminal 110 may be replaced with the second advertisement information, such that the second advertisement information may be displayed or otherwise presented via mobile terminal 110. For example, when a waving motion is sensed in association with the mobile terminal 110 while a display advertisement is being displayed on the screen of the mobile terminal 110, motion information associated with (or preset for) the waving motion may be generated. The motion information may be transmitted to the advertisement providing system 700. The motion information receiver 720 may receive the transmitted motion information and provide the motion information to the advertisement information requesting unit 730. The advertisement information requesting unit 730 may request the advertisement platform 420 for the second advertisement information that is advertisement information formatted in another advertisement display form based on the motion information. When the second advertisement information is received, the advertisement information provider 710 may transmit the received second advertisement information to the mobile terminal 110, such as via one or more communication networks.

It is noted that the first advertisement information and the second advertisement information may be configured in different advertisement display forms (or different advertisement presentation forms) with respect to a single advertisement material or advertisement campaign. That is, with respect to a single advertisement material that an advertiser desires to disseminate, a plurality of items of advertisement information may be produced (or otherwise generate) in different advertisement display forms, such that the various items and forms of advertisement information may be provided to users 440 at mobile terminals 110 based on detected motions of the mobile terminal 110.

FIG. 8 is a flowchart of a process of providing an advertisement, according to exemplary embodiments. For illustrative purposes, the process will be described in association with the advertisement providing system 700 of FIG. 7. It is noted that the steps of the process may be performed in any suitable order, as well as combined or separated in any suitable manner.

In operation 810, the advertisement providing system 700 may receive, from an advertisement platform (e.g., advertisement platform 420), first advertisement information that is configured in a first advertisement display form, and may provide the received first advertisement information in the first advertisement display form to a mobile terminal 110 of a user 440. It is noted that the advertisement platform may correspond to an individual advertisement platform described above with reference to FIG. 4.

In operation 820, the advertisement providing system 700 may receive motion information that is generated based on a detected motion of the mobile terminal 110, such as detected while the first advertisement information in the first advertisement display format is being presented to the user 440 of the mobile terminal 110. The motion information may be generated based on the motion of the mobile terminal 110 that is sensed based on an output value of at least one sensor included in the mobile terminal 110. The output value may include an output value of the at least one sensor while the single item of advertisement information is being displayed (and/or otherwise presented) on the screen (or other component) of the mobile terminal 110. As described above, based on the motion of the mobile terminal 110 sensed while the single item of advertisement information is being displayed on the mobile terminal 110, advertisement information in a different advertisement display form may be provided to the is mobile terminal 110, such as via advertisement information provider 710, as will become more apparent below.

In operation 830, the advertisement providing system 700 may request the advertisement platform 420 for second advertisement information that is configured in another advertisement display form based on the motion information. The advertisement providing system 700 may verify the advertisement display form based on the motion information that is generated based on the detected motion of the mobile terminal 110, and may request the advertisement platform 420 for the second advertisement information configured in the verified (or second) advertisement display form, as the second advertisement information. As described in association with FIG. 7, the request for the second advertisement information may be generated and transmitted by advertisement information requesting unit 730. In this manner, it is also noted that the aforementioned verification process may also be performed by advertisement information requesting unit 730.

In operation 840, the advertisement providing system 700 may receive, in response to transmitting the request for the second advertisement information, the second advertisement information from the advertisement platform 420. The advertisement providing system 700 may transmit the second advertisement information in the second advertisement presentation format to the mobile terminal 110. The first advertisement information displayed on (or otherwise presented by) the mobile terminal 110 may be replaced with the second advertisement information, and the second advertisement information may be displayed or otherwise presented. For example, when a waving motion is sensed by the mobile terminal 110 while a display advertisement is being displayed on the screen of the mobile terminal 110, motion information associated with the waving motion may be generated, and may be is transmitted to the advertisement providing system 700. The advertisement providing system 700 may receive the transmitted motion information in operation 820. In operation 830, the advertisement providing system 700 may request the advertisement platform 420 for the second advertisement information via advertisement information requesting unit 730. As previously mentioned, the second advertisement information is advertisement information in the advertisement display form associated with the motion information generated based on the detected motion of the mobile terminal 110. The second advertisement information is received in operation 830, and the advertisement providing system 700 may transmit the received second advertisement information to the mobile terminal 110.

According to exemplary embodiments, the first advertisement information and the second advertisement information may be configured in different advertisement display (or presentation) forms with respect to a single advertisement material or campaign. That is, with respect to a single advertisement material that an advertiser desires to disseminate, a plurality of items of advertisement information may be produced in different advertisement display forms. These plurality of items of advertisement information in the variety of advertisement display forms may be stored in association with various detectable motion conditions (or information), which may be utilized by the advertisement providing system 500 to provide appropriate advertisement information in an appropriate display form based on received motion information.

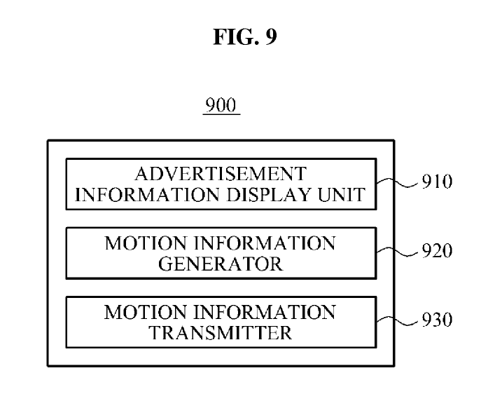

FIG. 9 is a block diagram of an advertisement providing system 900, according to exemplary embodiments. As described above, the advertisement providing system 900 may correspond to a mobile terminal 110 of a user 440. Referring to FIG. 9, the advertisement providing system 900 may include an advertisement information display unit 910, a motion information generator 920, and a motion information transmitter 930. It is noted that the is advertisement information display unit 910, the motion information generator 920, and the motion information transmitter 930 may be provided as hardware, software, or a combination thereof, such as one or more units, modules, processors, generators, transmitters, etc., or one or more processes executed by one or more units, modules, processors, generators, transmitters, etc.

The advertisement information display unit 910 may be configured to display, on a screen of a mobile terminal 110 of a user 440, first advertisement information that is received from a server, e.g., publisher 430. The first advertisement information may be displayed on the screen to be in a first advertisement display form that is used to configure the first advertisement information. It is also noted that the server may correspond to an individual publisher described above with reference to FIG. 4. It is also noted that the first advertisement information may be presented to the user in one or more additional and/or alternative forms other than via display, such as via one or more audible, tactile, and/or visual presentation forms via one or more corresponding components of the mobile terminal 110.

The motion information generator 920 may be configured to generate motion information based on a motion sensed while, for instance, the first advertisement information is being displayed on the screen. For example, the motion information may be generated based on a motion sensed that is sensed based on an output value provided from a sensor (not shown). Methods of sensing a motion of a mobile terminal using a sensor are known and thus, a further detailed description will be omitted here to avoid obscuring exemplary embodiments described herein. The advertisement providing system 900 may further include at least one sensor to provide an output value for sensing the motion, as well as one or more other components to execute the processes described herein.

The motion information transmitter 930 may be configured to transmit the is generated motion information to the server, such as the publisher 430. The server may request the advertisement platform 420 for advertisement information configured in an advertisement display form associated with the motion information. In response to the request, the server may receive the second advertisement information received from the advertisement platform 420 and may transfer the received second advertisement information to the advertisement providing system 900 as the second advertisement information. According to exemplary embodiments, the motion information transmitter 930 may be configured to transmit the motion information and/or the second advertisement information request to the advertisement platform 420. In this manner, the advertisement platform 420 may be configured to transmit the second advertisement information to the mobile terminal 110 directly or may be configured to transmit the second advertisement information to the mobile terminal 110 via the server, e.g., via the publisher 430.

When the second advertisement information is received from the server, the advertisement information display unit 910 may be configured to switch the screen on which the first advertisement information is displayed, and may be further configured to display the received second advertisement information. The second advertisement information may also be displayed on the screen in an advertisement display form that is used to configure the second advertisement information.

It is noted that the first advertisement information and the second advertisement information may be configured in different advertisement display forms with respect to a single advertisement material or campaign.

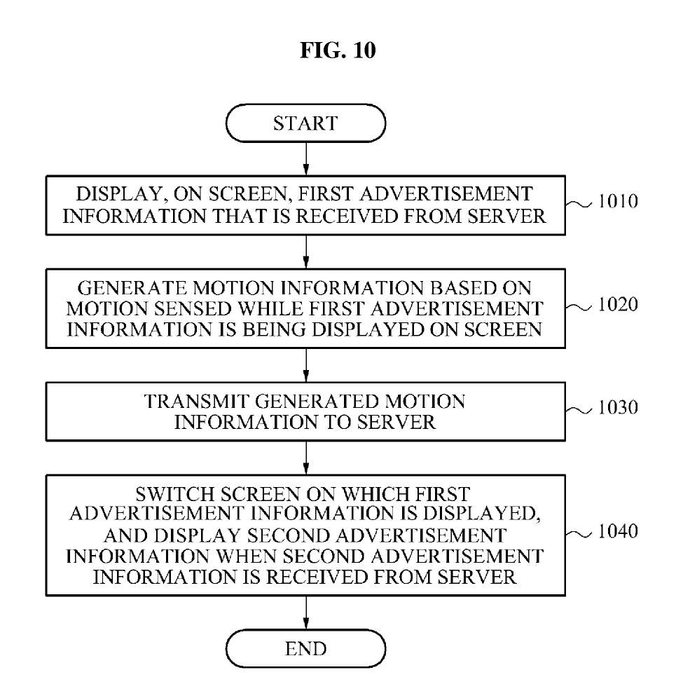

FIG. 10 is a flowchart of a process of providing an advertisement, according to exemplary embodiments. For illustrative purposes, the process will be described in association with the advertisement providing system 900 of FIG. 9. It is noted that the steps of the process is may be performed in any suitable order, as well as combined or separated in any suitable manner.

In operation 1010, the advertisement providing system 900 may display, on a screen of a mobile terminal 110 of a user 440, first advertisement information that is received from a server, e.g., publisher 430. Here, the first advertisement information may be displayed on the screen to be in a first advertisement display form that is used to configure the first advertisement information. It is noted that the server may correspond to an individual publisher described above with reference to FIG. 4.

In operation 1020, the advertisement providing system 900 may generate motion information based on a motion sensed while the first advertisement information is being displayed on the screen. For example, the motion information may be generated based on a motion sensed that is sensed based on an output value provided from a sensor (not shown). Methods of sensing a motion of a mobile terminal 110 using a sensor are known, and thus, a further detailed description will be omitted here to avoid obscuring exemplary embodiments described herein. The advertisement providing system 900 may further include at least one sensor to provide an output value for sensing the motion, as well as one or more other components to execute the processes described herein.

In operation 1030, the advertisement providing system 900 may transmit the generated motion information to the server via, for instance, one or more communication networks, e.g., one or more wired/wireless communication networks. Here, the server (e.g., publisher 430) may request the advertisement platform (e.g., advertisement platform 420) for advertisement information configured in an advertisement display form associated with the motion information. In response to the request, the server 430 may receive the advertisement is information from the advertisement platform 420 and may transfer the received advertisement information to the advertisement providing system 900 as the second advertisement information.

When the second advertisement information is received from the server 430, the advertisement providing system 900 may switch the screen on which the first advertisement information is displayed, and may display the received second advertisement information in operation 1040. As previously mentioned, the first and/or second advertisement information may be presented to users via one or more audible, tactile, and/or visual components of the mobile terminal 110 and, therefore, exemplary embodiments described herein are not to be limited to the “display” examples alone. Further, the second advertisement information may also be presented in an advertisement display form that is used to configure the second advertisement information. To this end, the first advertisement information and the second advertisement information may be configured in different advertisement display forms with respect to a single advertisement material or campaign.

According to exemplary embodiments, it is possible to arouse, and thereby, induce the interest of a user via a mobile advertisement by expanding a displayed advertisement based on a detected motion of a mobile terminal or by providing content of a moving picture and/or the like associated with the displayed advertisement.

Also, according to exemplary embodiments, it is possible increase an advertising effect on a side of an advertiser, and to increase advertising sales on a side of a media by more conveniently providing a user with additional advertisement information based on a motion of a mobile terminal that occurs in response to an action of a user waving or rotating the mobile terminal while first advertisement information is being presented to the user.

According to exemplary embodiments, the features, functions, and/or processes is described herein may be recorded in computer-readable media including program instructions to implement various operations embodied by a computer. The media may also include, alone or in combination with the program instructions, data files, data structures, and the like. The media and program instructions may be those specially designed and constructed for the purposes of the exemplary embodiments described herein, or they may be of the kind well-known and available to those having skill in the computer software arts. Examples of computer-readable media include magnetic media, such as hard disks, floppy disks, and magnetic tape; optical media (such as CD ROM disks and DVD); magneto-optical media (such as optical disks); and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations of the above-described exemplary embodiments.

While certain exemplary embodiments and implementations have been described herein, other embodiments and modifications will be apparent from this description. Accordingly, the invention is not limited to such embodiments, but rather to the broader scope of the presented claims and various obvious modifications and equivalent arrangements.

What is claimed is:

1. A system, comprising:
an advertisement information managing module configured to manage a plurality of items of advertisement information configured in a corresponding plurality of different advertisement presentation formats, the plurality of items of advertisement information being associated with a single advertisement material; and
an advertisement information providing module configured to provide one of the plurality of items of advertisement information,
wherein the one item of advertisement information is provided to a mobile terminal and is configured to be presented via the mobile terminal according to a first one of the plurality of advertisement presentation formats, and
wherein the advertisement information providing module is further configured to provide another one of the plurality of items of advertisement information to the mobile terminal based on motion information associated with a detected motion of the mobile terminal.

2. The system of claim 1, wherein:
the motion information is generated based on an output value of at least one sensor associated with the mobile terminal; and
the motion of the mobile terminal is detected while the one item of advertisement information is being presented via the mobile terminal.

3. The system of claim 1, wherein the different advertisement presentation formats comprise at least one of:
a first advertisement presentation format for advertisement information that is displayed on an advertisement area of a page accessed by the mobile terminal;
a second advertisement presentation format for advertisement information that is displayed on a layer overlaid on a page accessed by the mobile terminal;
a third advertisement presentation format for advertisement information that is displayed on a popup page that is popped up in association with a page accessed by the mobile terminal;
a fourth advertisement presentation format for advertisement information that is displayed in response to control of an application installed on the mobile terminal;
a fifth advertisement presentation format for advertisement information in which a size or content of the advertisement information configured in one of the first advertisement presentation format through the fourth advertisement presentation format is expanded;
a sixth advertisement presentation format for advertisement information that is configured as a moving picture; and
a seventh advertisement presentation form for advertisement information that is displayed on a landing page accessed by the mobile terminal.

4. A system, comprising:
an advertisement information providing module configured to:
receive, from an advertisement platform, first advertisement information configured in association with a first advertisement presentation format, and
provide the first advertisement information to a mobile terminal;
a motion information receiver configured to receive motion information generated based on a motion of the mobile terminal; and
an advertisement information requesting module configured to request, based on the motion information, the advertisement platform for second advertisement information configured in association with a second advertisement presentation format,
wherein the advertisement information providing module is further configured to:
receive the second advertisement information from the advertisement platform, and
provide the second advertisement information to the mobile terminal, and
wherein the first advertisement information and the second advertisement information are both associated with the same advertisement material.

5. The system of claim 4, wherein:
the motion information is generated based on an output value of at least one sensor associated with the mobile terminal; and
the motion of the mobile terminal is detected while the first item of advertisement information is being presented via the mobile terminal.

6. The system of claim 4, wherein the first and the second advertisement presentation format comprise at least one of:
a first advertisement presentation format for advertisement information that is displayed on an advertisement area of a page accessed by the mobile terminal;
a second advertisement presentation format for advertisement information that is displayed on a layer overlaid on a page accessed by the mobile terminal;
a third advertisement presentation format for advertisement information that is displayed on a popup page that is popped up in association with a page accessed by the mobile terminal;
a fourth advertisement presentation format for advertisement information that is displayed in response to control of an application installed on the mobile terminal;
a fifth advertisement presentation format for advertisement information in which a size or content of the advertisement information configured in one of the first advertisement presentation format through the fourth advertisement presentation format is expanded;
a sixth advertisement presentation format for displaying advertisement information that is configured as a moving picture; and
a seventh advertisement presentation format for advertisement information that is displayed on a landing page accessed by the mobile terminal.

7. A method, comprising:
presenting, via a mobile terminal, advertisement information;
detecting, via the mobile terminal, motion of the mobile terminal while the advertisement information is being presented; and
switching, in response to detecting the motion, presentation of the advertisement information to presentation of related advertisement information,
wherein the advertisement information is presented in a different advertisement presentation format than the related advertisement information.

8. The method of claim 7, further comprising:
generating, in response to detecting the motion, motion information.

9. The method of claim 7, wherein the different advertisement presentation formats comprise at least one of:
presentation of advertisement information via display on an advertisement area of a page accessed by the mobile terminal;
presentation of advertisement information via display on a layer overlaid on a page accessed by the mobile terminal;
presentation of advertisement information via display on a popup page that is popped up in association with a page accessed by the mobile terminal;
presentation of advertisement information via a display controlled in association with an application installed on the mobile terminal;
presentation of advertisement information in an expanded display;
presentation of advertisement information via a moving picture; and
presentation of advertisement information via display on a landing page accessed by the mobile terminal.

10. A computer-readable storage medium configured to store at least one program, wherein the at least one program comprises instructions that when executed by at least one processor are configured to cause the at least one processor at least to:
present advertisement information via a mobile terminal;
detect motion of the mobile terminal; and
switch, in response to detection of the motion, presentation of the advertisement information to related advertisement information,
wherein the advertisement information is presented in a different presentation format than the related advertisement information.

11. The method of claim 7, wherein the advertisement information and the related advertisement information are associated with the same advertisement campaign.

12. The method of claim 7, further comprising:
transmitting, via at least one communication network, the motion information;
receiving, in response to transmitting the motion information, the related advertisement information via the at least one communication network.

13. The method of claim 12, wherein switching presentation of the advertisement information to the related advertisement information is further in response to receiving the related advertisement information via the at least one communication network.

14. The method of claim 8, further comprising:
retrieving, based on the motion information, the related advertisement information.

15. The method of claim 14, wherein switching from presentation of the advertisement information to the related advertisement information is further in response to retrieving the related advertisement information.

16. The method of claim 7, wherein the motion of the mobile terminal corresponds to at least one of a waving motion, a horizontal rotational motion, and a vertical rotational motion.

17. The method of claim 16, further comprising:
presenting a motion hint corresponding to at least one of the waving motion, the horizontal rotational motion, and the vertical rotational motion
